(19) United States
(12) Patent Application Publication
(10) Pub. No.: US 2024/0155532 A1
(43) Pub. Date: May 9, 2024

(54) ONBOARDING A DEVICE WITH NO HOME NETWORK

(71) Applicant: InterDigital Patent Holdings, Inc., Wilmington, DE (US)

(72) Inventors: Guanzhou Wang, Brossard (CA); Michael Starsinic, Newtown, PA (US); Saad Ahmad, Montreal (CA)

(73) Assignee: InterDigital Patent Holdings, Inc., Wilmington, DE (US)

(21) Appl. No.: 18/501,742

(22) Filed: Nov. 3, 2023

Related U.S. Application Data
(60) Provisional application No. 63/422,291, filed on Nov. 3, 2022.

(51) Int. Cl. H04W 60/00; H04W 12/06

(52) U.S. Cl. CPC H04W 60/00; H04W 12/06

(57) ABSTRACT

One or more systems, devices, and/or methods may address approaches and use techniques described herein to onboard a device when the device does not have a predetermined home network. The device may indicate, explicitly or implicitly, that it does not have a home network to an onboarding network. The onboarding network may authenticate the device, then provide the device with a provisioning server address. The onboarding network may initiate a unified data management service, and provide the provisioning server with a temporary identifier for the device. The device may establish a connection with the provisioning server, and provide the temporary credentials to the device. The device may use the temporary credentials to register with the onboarding network.

### CROSS-REFERENCE TO RELATED APPLICATIONS

This application claims the benefit of U.S. Provisional Application No. 63/422,291, filed Nov. 3, 2022, the contents of which are incorporated herein by reference in its entirety.

### BACKGROUND

There may be use cases where extremely low energy, or no energy, devices exist for various purposes (e.g., tracking products). There is a need to establish a procedure to onboard these devices into a system using one or more other devices, given their unique properties.

### SUMMARY

One or more systems, devices, and/or methods may address approaches and use techniques described herein to onboard a device when the device does not have a predetermined home network. The device may indicate, explicitly or implicitly, that it does not have a home network to an onboarding network. The onboarding network may authenticate the device, then provide the device with a provisioning server address. The onboarding network may initiate a unified data management service, and provide the provisioning server with a temporary identifier for the device. The device may establish a connection with the provisioning server, and provide the temporary credentials to the device. The device may use the temporary credentials to register with the onboarding network.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 10 is a system diagram illustrating an example radio access network (RAN) and an example core network (CN) that may be used within the communications system illustrated in FIG. 1A according to an embodiment;

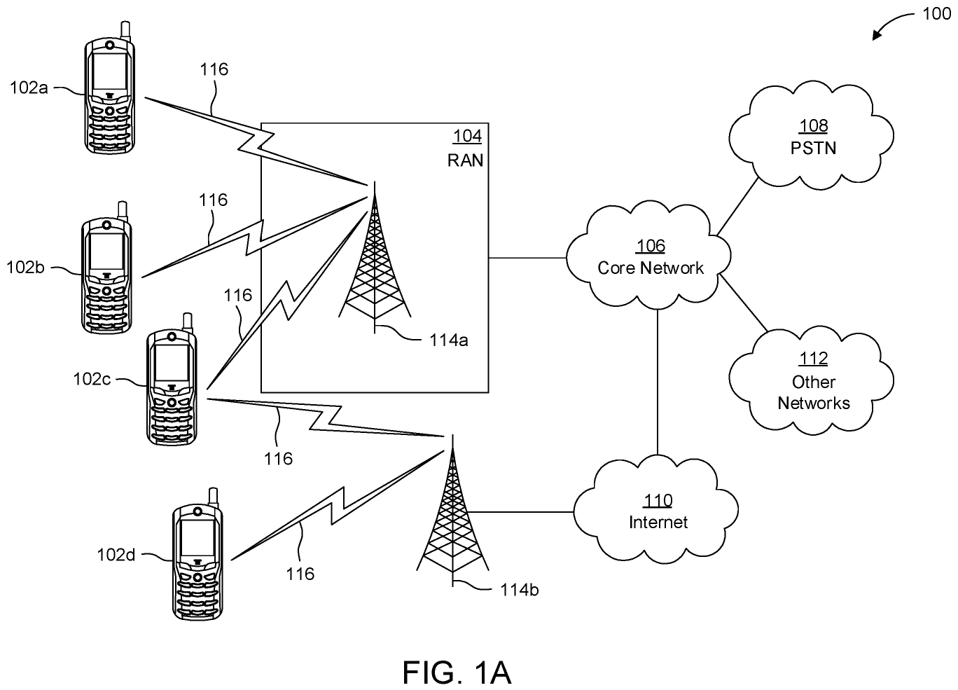

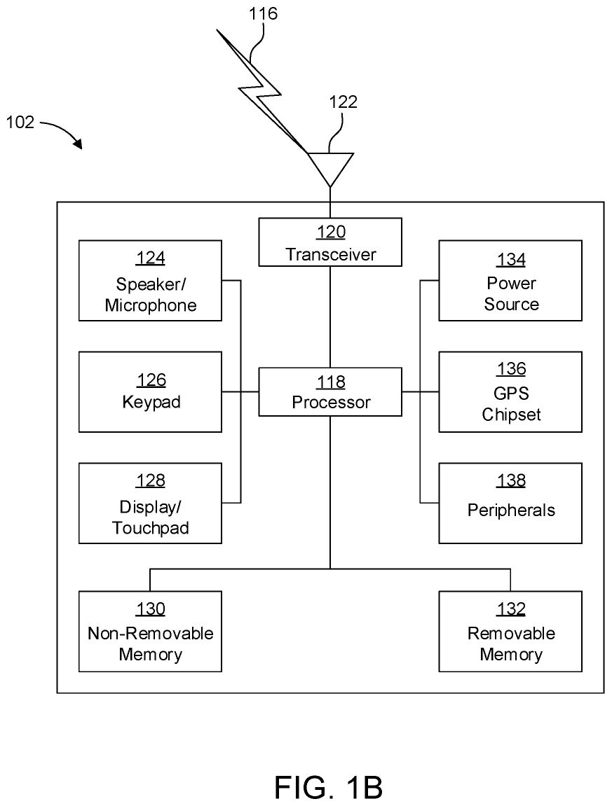

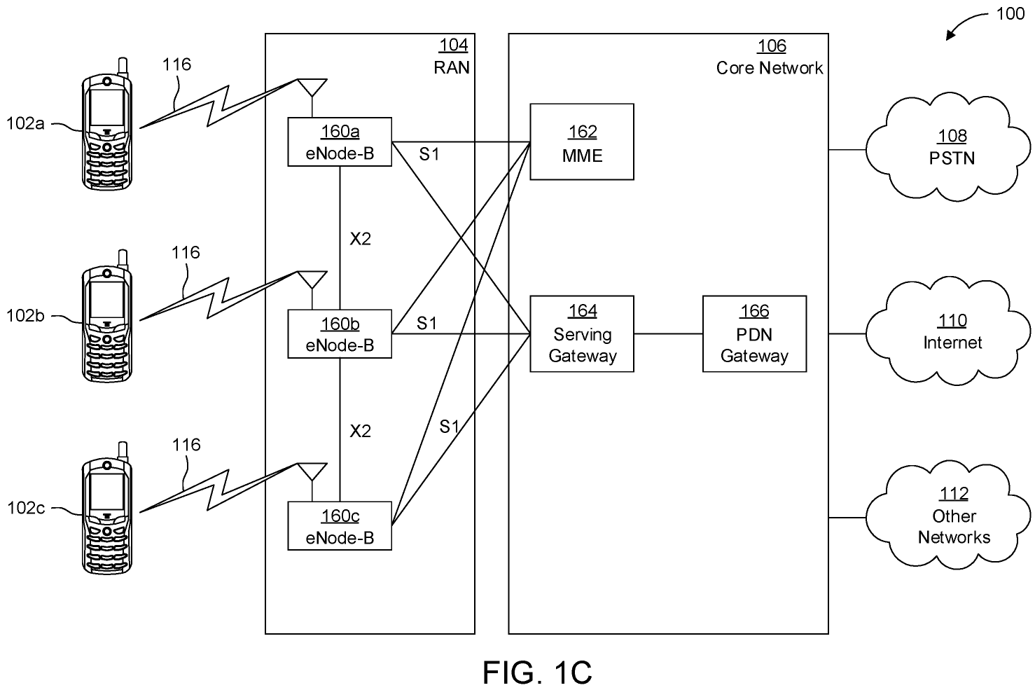

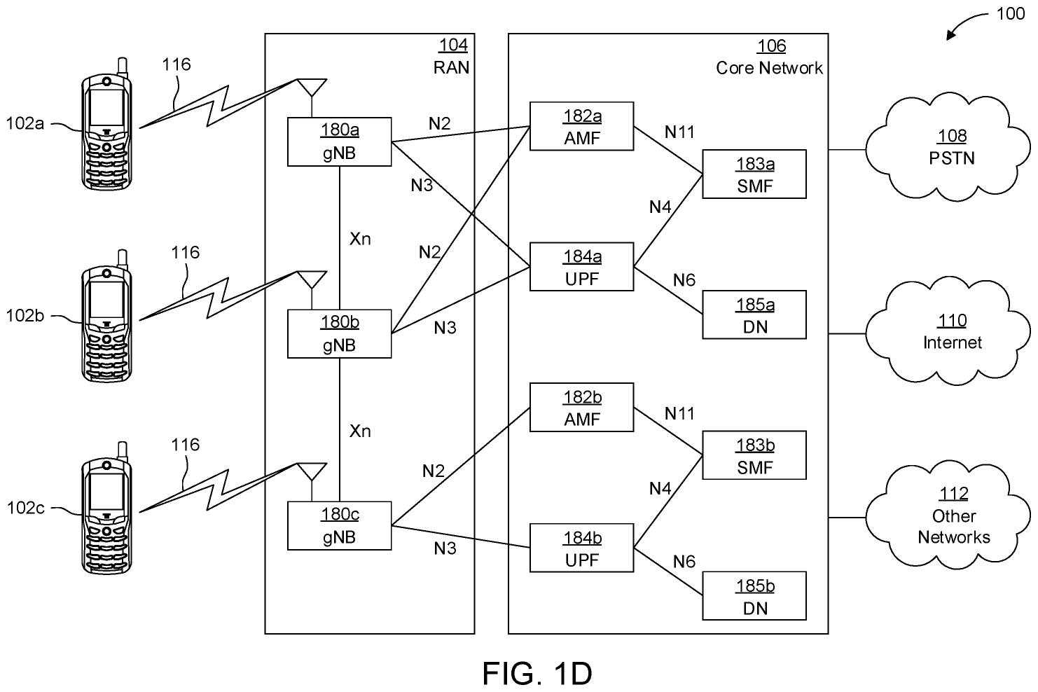

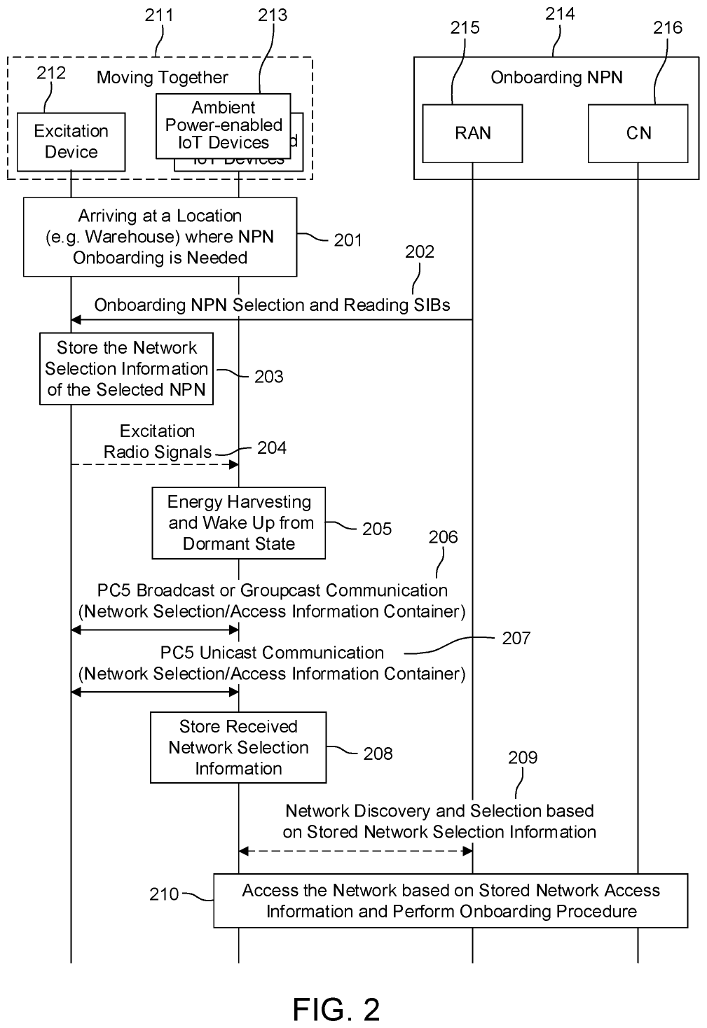

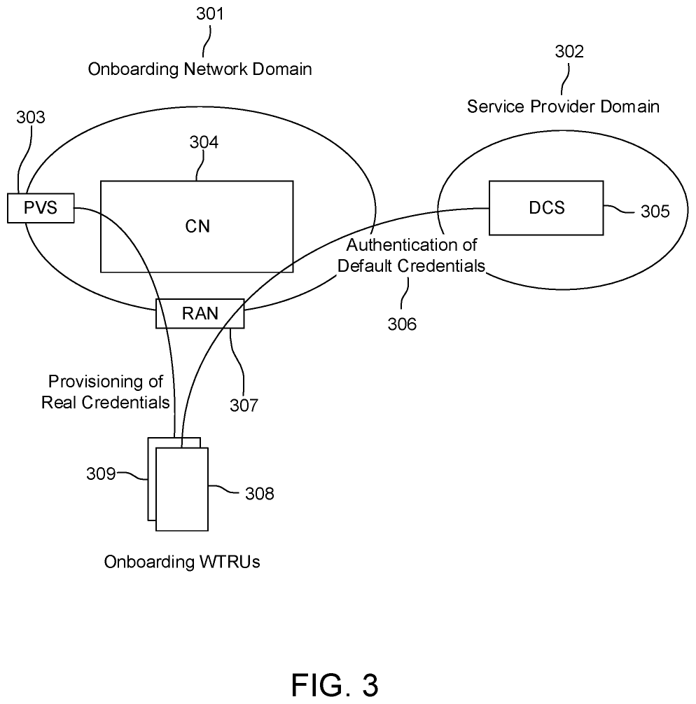

FIG. 1D is a system diagram illustrating a further example RAN and a further example CN that may be used within the communications system illustrated in FIG. 1A according to an embodiment;

FIG. 2 Excitation Device assisted network discovery and selection for ambient power-enabled IoT devices;

FIG. 3 illustrates an example Network architecture for supporting onboarding without a predetermined home network;

FIG. 4 illustrates an example of an enhanced onboarding procedure for home-network-less WTRUs; and

FIG. 5 illustrates an example process according to one or more techniques described herein.

### DETAILED DESCRIPTION

One or more of the following acronyms may be referenced herein: 5GC (5G Core network), 5GS (5G System), AAA (Authentication Authorization Accounting), AUSF (Authentication Server Function), CN (Core Network), CP (Control Plane), DCS (Default Credentials Server), IoT (Internet of Things), MO (Mobile Originated), MT (Mobile Terminated), NPN (Non-Public Network), NSSAAF (Network Slice-specific and SNPN Authentication and Authorization Function), PLMN (Public Land Mobile Network), PNI-NPN (Public Network Integrated NPN), ProSe (Proximity based Services), PVS (Provisioning Server), RAN (Radio Access Network), SNPN (Standalone Non-Public Network), SUCI (Subscription Concealed Identifier), SUPI (Subscription Permanent Identifier), UDM (Unified Data Management), UP (User Plane), PC5 (The reference point between ProSe-enabled UEs used for control and user plane for 5G ProSe Direct Discovery, 5G ProSe Direct Communication and 5G ProSe UE-to-Network Relay), and/or, Uu (The air interface between UE and 3GPP radio access network).

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA-F). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (10), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 18 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

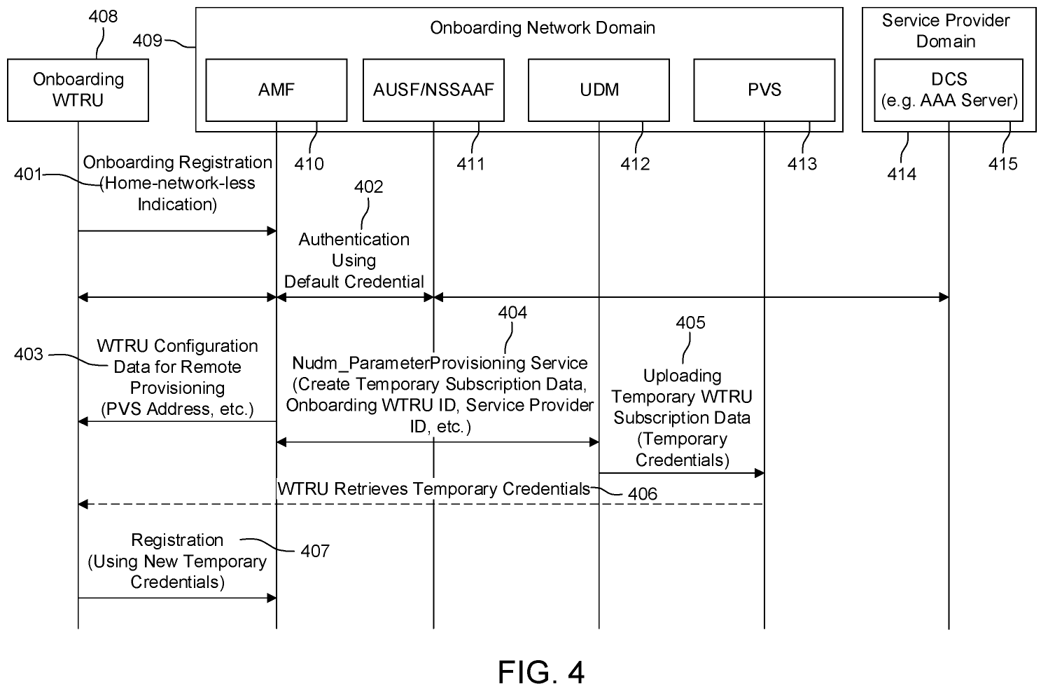

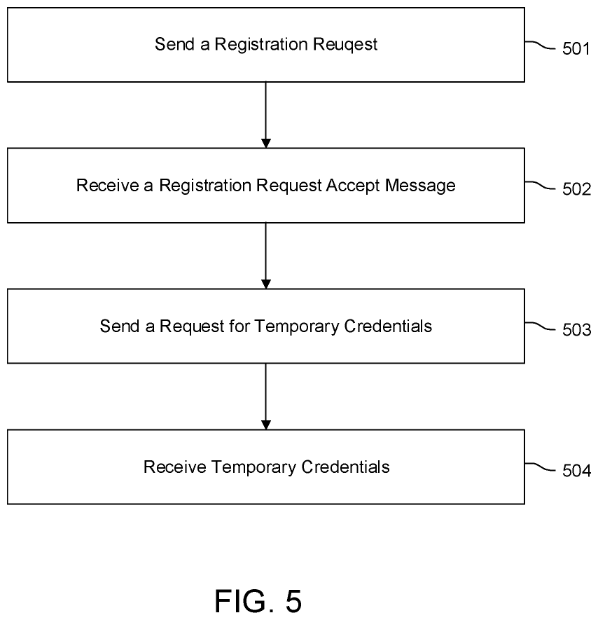

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MI MO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MI MO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Ambient power-enabled IoT devices are a kind of IoT device that can harvest energy from the environment, such as wireless radio waves, motion, vibration, piezoelectricity, solar and wind power, etc. They are either battery-less or have limited energy storage (e.g., using a capacitor). Ambient power-enabled IoT devices may find its usage in Industrial Wireless Senor Networks where the environment is harsh (e.g., extremely high or low temperature) and requires devices to be battery-less, maintenance-free, and long service life. They also play an important role in Smart Logistics and Smart Warehousing. The low-cost, small-form, battery-lessness, and durability make them suitable to be attached to huge amounts of goods and facilitate more efficient goods identifying, sorting, tracking and inventory. As discussed herein, an ambient power-enabled IoT device and WTRU may be interchangeable.

Non-Public Networks (NPN) are 5G networks that are intended for the use of a private entity such as an enterprise and only the authorized users can access these private networks. In some cases, there may be standardization (e.g., 3GPP) for Non-Public Networks. There may be two types of NPN, Standalone NPN (SNPN) and Public Network Integrated NPN (PNI-NPN). A SNPN is a standalone NPN that does not have an interface or interconnections with other PLMNs or NPNs. A PNI-NPN is a NPN that is deployed using the resource (e.g., RAN, network slice) of a PLMN. A WTRU that can access a SNPN may need to have the subscription to the SNPN, including the Subscription Identifier (SUFI) and the credentials for the subscribed SNPN. Optionally, the WTRU may also use a Credential Holder's credentials to access the SNPN.

When a WTRU is not provisioned with the SNPN subscription information and needs to access a SNPN, it may use an “onboarding” procedure to acquire subscription information through a “onboarding network” which may also be a SNPN. The WTRU may use a default credential to register with the onboarding network. If the default credential is successfully authenticated by a Default Credential Server, the WTRU may establish a temporary User Plane connection in the onboarding network and use the connectivity to access a Provisioning Server and retrieve the subscription information from the Provisioning Server.

In typical use cases of ambient power-enabled IoT devices, they may be served by NPNs instead of public networks. Especially in Smart Logistics and Warehousing scenarios, the serving NPNs may change from time to time, as the goods that the IoT devices are attached to move from one location (e.g., warehouse) to another. The IoT devices may not have a fixed subscription to a particular NPN and may use NPN onboarding procedure to obtain access to any NPN that serves its current location.

Because the ambient power-enabled IoT devices are power constrained, they are not supposed to keep searching for suitable networks as a normal WTRU usually does. The ideal situation may be that these devices are dormant for the most of the time, and start to turn on its transceiver to search for an available network when it needs the network service, for example, on arrival at a new warehouse where inventory needs to be performed, or when passing a toll-gate where the information needs to be collected for tracking purpose. Therefore, there needs to be mechanism that can trigger an ambient power-enabled IoT device or a group of ambient power-enabled IoT devices, at a desired time and/or location, to search for and select a serving network.

It also becomes more difficult for a IoT device/WTRU to rely on its preconfiguration to select a onboarding SNPN as the device/WTRU needs to access many various NPNs at different locations. New methods that enable the IoT device/WTRU to correctly identify and select its onboarding NPN are needed.

In some cases, a WTRU performing onboarding procedure may have a predetermined Home Network and the WTRU acquires the credentials of the predetermined Home Network through the onboarding procedure. The Default Credential Server, which authenticates the WTRU's preconfigured default credential during the onboarding Registration procedure, and the Provisioning Server, which provides the home network credential to the WTRU through the User Plane remote provisioning procedure, may reside in the WTRU's Home Network domain. The WTRUs are supposed to leave the onboarding network after the onboarding and remote provisioning procedure are completed and turns to its Home Network.

In the case of Smart Logistics and Warehousing, the ambient power-enabled IoT devices may not have a predetermined home network. When they arrive at a warehouse, they may first perform the onboarding procedure with the NPN serving the warehouse, and after that, instead of going to a predetermined Home Network, they may stay with the onboarding NPN which becomes their serving network. After a while, the IoT devices may be transported to another warehouse and repeat the procedure with another NPN serving the new warehouse.

In some cases, an NPN onboarding and provisioning procedure may need to be modified to handle this scenario where onboarding WTRUs don't have a predetermined Home Network and there may not exist a PVS that has their home network credentials readily available.

In Smart Logistics and Warehousing use cases, a large number of IoT devices may move together. Each IoT device needs to perform an onboarding procedure to obtain network access when it arrives at a new location served by a new NPN. Simultaneous onboarding requests from a large number of devices around the same time may cause congestion in the network. Performing the onboarding procedure individually for each IoT device may also take a longer amount of time and may not be economical from the perspective of power consumption.

There may be one or more approaches that use one or more techniques to address the issues discussed herein. In some cases, a WTRU (e.g., ambient IoT power device) network discovery and selection may be aided by one or more excitation devices. An Excitation Device, which is not power constrained, may help other ambient power-enabled IoT devices discover and select the onboarding/serving NPN or PLMN by providing network discovery and selection configurations through sidelink communication.

An Excitation Device may be a normal WTRU (e.g., 5G WTRU) or a special device that is capable of communicating with a 3GPP network (e.g., an NPN). It may also be capable of communicating with other ambient power-enabled IoT devices via sidelink technologies (e.g., PC5, Bluetooth, WiFi-Direct, NFC, etc.) The Excitation Device may move with a group of ambient power-enabled IoT devices, and it may be preconfigured with the information of the accompanying IoT devices, such as the device identifiers (e.g., SUPIs, L2 identifiers for sidelink communication, etc.). and sidelink communication parameters (e.g., spectrum used for sidelink communication, etc.).

The Excitation Device may perform one or more functionalities.

For example, an Excitation Device may start broadcasting short-range wireless radio waveforms that may provide energy that can be harvested by one or more accompanying IoT devices. This may also excite the IoT devices to “wake up” from a dormant state.

For example, an Excitation Device may search for available PLMNs or NPNs and select the network that will serve the accompanying IoT devices. It may read and store the System Information Broadcast of the selected network, such as the network identifiers and SIBs related to network selection and access.

For example, an Excitation Device may initiate the sidelink communication (e.g., PC5 broadcast or unicast communication) with the accompanying IoT devices and provide the network selection-related information that it has acquired. It may also instruct the IoT devices to switch the communication mode from sidelink to cellular link (e.g., Uu link) and try to select the proper NPN or PLMN.

FIG. 2 illustrates an example method of an Excitation Device that assists one or more ambient power-enabled IoT devices in discovering and selecting a network. In this example, there may be one or more Excitation

Device 212 and an Ambient Power-enabled IoT device(s) 213. In one instance, the Excitation Device 212 and the IoT Device 213 may move together 211. In one instance, the Excitation Device 212 may be brought into functional proximity (e.g., within excitation radio signal range, communication range, etc.) with the IoT device 213 dynamically for the purposes of onboarding the IoT device 213.

As shown, at 201 the Excitation Device 212 (e.g., a first WTRU) and one or more IoT device(s) 213 (e.g., one or more second WTRUs) may be in functional proximity to each other (e.g., moving together and/or arriving at a location, such as a warehouse) where the IoT devices 213 need to access a non-public network (NPN) (e.g., onboarding NPN) 214 for some purpose related to a specific use case (e.g., smart inventory, where the IoT devices are attached to inventory). The IoT device may be in a dormant state to conserve energy.

At 202 and 203, the Excitation Device 212 may select a network (e.g., a PLMN not shown, or an NPN 214 as shown, but in either case this procedure may be the same or similar) that the IoT device needs to access. The Excitation Device 212 may select and access the NPN 214 based on stored configuration information and/or user input. The Excitation Device 212 may also receive, and store at 203, discovery information (e.g., network ID, SIB information, etc.) sent from the NPN 214 that is related to network access control (e.g., SIB1 of a NR cell that contains cellSelection Info and/or cellAccessRelatedInfo that contain the PLMN or NPN identifiers).

In one instance, the Excitation Device 212 may perform a discovery procedure with the NPN 214, to get discovery information for itself and/or the IoT device. The Excitation Device 212 may send a discovery message to the NPN 214, and may include information about itself and/or information about the IoT device 213. For example, the discovery message may include a device type, ambient IoT application information, excitation capability, and/or the like.

In one instance, the Excitation Device 212 may have preconfigured discovery information, that may be sent to the IoT device 213 (e.g., sending a PC5 announce discovery message, as described herein).

The Excitation Device 212 may determine whether the IoT device 213 is allowed to access the NPN 214 (e.g., based on the network UAC barring information, such as in SIB1). For example, if the IoT device 213 is not allowed to access the network, the remaining process may not be performed, or the determination (e.g., whether the IoT device 213 is allowed for access) may be repeated in the event of some variable changing (e.g., there was an error, information needed to be updated, a configured amount of time has passed, a trigger event has occurred, etc.).

Determining whether the IoT device 213 is allowed to access the target network may involve the Excitation Device performing an onboarding procedure with the PLMN or NPN 214 and receiving, from the PLMN or NPN 214, the Network Selection and Access Information that will be used at the point of exchanging network access information between the Excitation Device 212 and the IoT device 213 (e.g., 206 and 207). The Excitation Device 212 may also receive an indication from the PLMN or NPN 214 that initiating onboarding for the IoT device 213 is allowed, when to initiate the onboarding for the IoT device 213, what locations the Excitation Device 212 should be in when initiating the onboarding procedure for the IoT device 213, and the identity(s) of the IoT device(s) 213 that may be onboarded.

At 204, the Excitation Device 212 may broadcast one or more short-range radio signals as an external trigger to the IoT device 213; this may be performed based on user input and/or triggered based on a distance threshold between the Excitation Device 212 and the NPN 214 (e.g., by detecting that the Excitation Device is near a particular NPN or toll gate where incoming inventory is checked in). Alternatively/additionally, the Excitation Device 212 may broadcast (e.g., periodically, or based on proximity) an energy signal to wake up the IoT device 213.

At 205, the IoT device 213 may harvest energy from one or more radio signals (e.g., sidelink, energy wakeup signals, NFC, etc.) sent by the Excitation Device 212. The IoT device 213 may be pre-configured with a prioritized communication mode (e.g., Sidelink mode or Cellular link mode), which will be used after the IoT device 213 wakes up. The configuration related to the prioritized communication mode (e.g., spectrum for the sidelink communication, power control parameters, L2 identifiers for sidelink communication, etc.) may also be stored in the device. For example, if the prioritized communication mode is Sidelink, the IoT device 213 may start monitoring the sidelink discovery or communication request over the configured spectrum. In one instance, there may be one or more discovery filters preconfigured in the IoT device 213 so that it can monitor/receive the onboarding discovery announcement.

At 206, the Excitation Device 212 may use PC5 broadcast or groupcast mode to deliver Network Selection and Access Information to (e.g., a plurality of) the IoT device 213. This information may include: target network identifier, such as a PLMN ID or an NPN ID; target cell identifier; spectrum info of the target network; SIBs of the target network that are related to cell selection and access (e.g., SIB1); and/or, a communication mode in the target network (e.g., Mobile Originated only, or Mobile Terminated only, or both MO and MT).

At 207, alternatively, the Excitation Device 212 may use PC5 unicast mode to establish a PC5 link with (e.g., each) IoT device 213. The Excitation Device 212 may be pre-configured with the sidelink communication parameters for the IoT device 213, such as L2 identifier of the IoT device 213. The Excitation Device 212 may deliver the Network Selection and Access Information to the IoT device 213, and receive confirmation from the IoT device 213 over unicast link(s). Additionally, the Excitation Device 212 may generate and provide randomized timers to (e.g., each) IoT device 213 to spread out the time that the IoT devices access the network. In one instance, where there is a large number of accompanying IoT devices, the timers may help avoid the potential network congestion caused by massive simultaneous accesses.

Other technologies, such as Bluetooth, Wi-Fi, etc., may also be used to deliver the information.

At 208, the IoT device 213 may store the Network Selection and Access Information received from the Excitation Device over the sidelink.

At 209, the IoT device 213 may search for the target network/cell based on stored Network Selection and Access Information (e.g., using the same or different communication methodology that was used to communicate with the Excitation Device 212).

At 210, the IoT device 213 may skip reading SIBs of the target network and rely on the stored Network Selection and Access Information to access the network (e.g., that was received from the Excitation Device 212). The IoT device 213 may perform an onboarding procedure in the selected network (e.g. NPN 214) and retrieve the credentials for the network.

There may be several benefits of using an Excitation Device to assist other IoT devices for network discovery and selection.

For example, one benefit may be that the Excitation Device is not power-constrained and can take user input. The user may determine when is the best time to excite other IoT devices (e.g., on arrival at a warehouse). This eliminates the need for other IoT devices to search for suitable networks continuously.

For example, one benefit may be that when it is not possible to pre-configure onboarding network identifiers in the IoT devices, the Excitation Device can identify the proper network before IoT devices start searching for the network. The Excitation Device can also take the user's manual input to select the exact network that the IoT devices are intended to access. The network identifier selected by the Excitation Device can be communicated to the IoT devices via sidelink.

For example, one benefit may be that the Excitation Device can read network access-related SIB info from the selected network and communicate it to the IoT devices via sidelink. So, the IoT devices do not need to read SIB information themselves, which will not only speed up the network access procedure but also save power for the devices.

For example, one benefit may be that the Excitation Device can direct the accompanying IoT devices to access the network in a spread-out manner, instead of all at the same time, to avoid potential network congestion.

In some cases, IoT devices may be onboarded without a predetermined home network. In this approach, it may be assumed for non-limiting demonstration purposes that the ambient power-enabled IoT devices are provided or owned by a service provider (e.g., Smart Logistics Service Provider). The default credentials stored in the devices for onboarding purposes may be preconfigured by the service provider and the Default Credential Server (DCS), which can authenticate the default credentials, may reside in the service provider domain. The Provision Server may be in the onboarding network domain and the PVS may dynamically create the credentials for those onboarding WTRUs/devices that don't have a predetermined Home Network or don't have an associated PVS. The onboarding WTRUs/devices may retrieve the credentials from the PVS in the onboarding network domain and after that, it treats the onboarding network as its home network.

In contrast to the example of FIG. 2, in some cases, the excitation device may have already communicated with the IoT device to acquire information necessary to carry out the procedure of FIG. 3. For example, the Excitation Device may communicate (e.g., send an excitation signal, then begin communicating using the woken up radio) with the IoT device to acquire IoT identity, capability, and/or security information, which then may be used by the Excitation Device to acquire configuration information from the network for the IoT device, thereby enabling the Excitation Device to perform these tasks for the IoT device, and resulting in the IoT device using comparatively less power.

FIG. 3 illustrates an example network architecture for supporting onboarding without a predetermined home network, showing a relationship between the Service Provider domain and the Onboarding Network domain.

A shown, there is an Onboarding Network Domain 301, which may have a Provisioning Server (PVS) 303, a Core Network (CN) 304, and a RAN 307. There may also be a Service Provider Domain 302, which may include a Default Credential Server (DCS) 305. There may be one or more WTRUs 309 and 308 (e.g., IoT devices) that need to be onboarded.

The onboarding network 301 may generate and provision (e.g., 310) onboarding WTRUs 109/308 with its own credentials (e.g., dynamically created real credentials sent from the PVS 303), where the network 301 broadcasts an additional indication in its RAN 307 about this capability.

For WTRUs (e.g., 309/308) that need to perform onboarding without a predetermined home network, the configured onboarding SUPI or SUCI may have a special reserved coding of the home network identifier. The coding of the home network identifier part in SUPI or SUCI may point to the Service Provider (e.g., by including the Service Provider's domain name in the identifier) and may also indicate that the onboarding WTRU is without a predetermined home network.

When an onboarding WTRU 308/309 initiates Onboarding Registration, it may include an explicit indication that the onboarding WTRU 308/309 is without a predetermined home network. The onboarding network 301 may also recognize that the onboarding WTRU 308/309 is without a home network based on the special coding of the home network identifier part in the onboarding SUPI or SUCI. These WTRUs 308/309, at 306, may authenticate the credentials 310 with the DCS 305. After the authentication 306 with the DCS 305 is successful, the onboarding network 301 may perform a procedure in addition to a legacy onboarding procedure: the onboarding network 301 may provide its own PVS address to the onboarding WTRUs 308/309; and/or, the onboarding network 301 (e.g., AMF) may initiate a service procedure (e.g., with the UDM and PVS) to dynamically create temporary credentials for the onboarding WTRUs. In the figure, the “real” credentials is used as against the preconfigured “default” credentials, as the former may be used as the actual credential in the serving NPN; additionally, the “temporary credential” received by IoT devices may also be actual credentials to be used, so these may be “real” credentials in the figure.

After a successful onboarding registration, the onboarding WTRU 308/309 may access the PVS via the user plane and retrieve the temporary credential (e.g., real credentials). The temporary credential may be associated with a valid period, and after it expires, the WTRU needs to perform the onboarding procedure again to obtain new credentials.

After the temporary credential is available, the WTRU may initiate a new registration with the current network using the temporary credentials.

FIG. 4 illustrates an example of an enhanced onboarding procedure for home-network-less WTRUs. In this example, there may be an onboarding WTRU 408, an on boarding network domain 409, and a service provider domain 414. The onboarding network domain 409 may include an AMF 410, an AUSF/NSSAF 411, a UDM 412, and/or a PVS 413. The service provider domain may include a DCS 415 (e.g., an AAA server).

At 401, a WTRU 408 may initiate Registration with a network 409 (e.g., for onboarding purposes, with a network node of the network 409, such as the AMF 410). The WTRU 408 may indicate it is without a predetermined Home Network in the onboarding Registration request. The network 409 may also recognize that the WTRU 408 is without a Home Network based on a special-coded home network identifier in the WTRU 409 identifier (e.g., SUPI, SUCI, etc.).

At 402, the WTRU 409 may undergo an authentication procedure. For example, the network 409 (e.g., utilizing one or more network nodes, such as the AMF 410 and/or the AUSF/NASSAF 411) may perform primary authentication with the DCS 415 (e.g., external to the network 409) to verify a default credential of the WTRU 408. This authentication procedure may include one or more messages sent/received.

At 403, the network 409 (e.g., by the AMF) may provide configuration information to the WTRU 408. The configuration information may include data for remote provisioning. For example, the configuration information may include one or more PVS addresses in its own domain (e.g., the domain of the network) to the WTRU 408.

At 404, the AMF 410 may initiate a UDM service (e.g., Nudm_ParameterProvision service and related information) to request the UDM 412 to create UDM information, such as temporary subscription data for the WTRU 408. The UDM information may also include a WTRU ID for the WTRU 408, a service provider ID for the WTRU 408, and/or other information.

At 405, after the creation of the UDM service, the UDM may upload the UDM information (e.g., temporary subscription data, credentials for the WTRU 408, etc.) that the WTRU 408 needs to retrieve to the PVS 413.

At 406, the WTRU 408 may establish a user plane connection and retrieve the UDM information from the PVS.

At 407, the WTRU 408 may initiate Registration (e.g., another registration) with the network 409, which is now considered to be the temporary home network, using the acquired information (e.g., UDM information).

In some cases, there may be a WTRU with no predefined Home Network. A WTRU (e.g., an IoT device) may send a registration request to a network. The request may include information that is indicative that the WTRU has no home network and information that can be used by the network to determine a DCS identity. The WTRU may perform an authentication procedure with a DCS (e.g., using the DCS identity). The WTRU may receive a registration accept message that includes a PVS address. The WTRU may establish a user plane connection with the PVS and receive network credentials. The WTRU may perform a second registration procedure with the network and use the network credentials in the second registration procedure. The WTRU may receive a time period during which the network credentials may be considered valid.

In some cases, where a WTRU may not have a home network, and a network node (e.g., an AMF, or any network device disclosed herein) may receive a registration request from a WTRU. The request may include information that is indicative that the WTRU has no home network and information that can be used by the network to determine a DCS identity. The AMF may perform an authentication procedure with the WTRU and DCS. The AMF may send a Registration Accept message that includes a PVS address. The AMF may send a request to a UDM to request the creation of temporary subscription data for the WTRU. The AMF may request the UDM to create temporary subscription data for the WTRU, which may include a WTRU identifier and credentials.

FIG. 5 illustrates an example process according to one or more techniques and/or approaches described herein. At 501, a WTRU (e.g., an IoT device) may send a registration request to a network. The registration request may indicate that the WTRU does not have a home network. This indication may be explicit or implicit. At 502, the WTRU may receive a registration accept message. The registration accept message may include an address of a provisioning server. At 503, the WTRU may send a request for temporary credentials to the provisioning server using the provisioning server address. Temporary credentials may be dynamically created by the network based on the registration request. At 504, the WTRU may receive the temporary credentials. The WTRU may then register with the network using the temporary credentials. In one instance, the WTRU device may be authenticated with a default credentials server prior to receiving the registration accept message. In one instance, sending the request for temporary credentials occurs after the WTRU establishes a user plane connection with the provisioning server. In one instance, the registration request includes a WTRU identifier, including a Subscription Permanent Identifier or a Subscription Concealed Identifier.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by a wireless transmit receive unit (WTRU), the method comprising:
sending a registration request message to a network, wherein the registration request message indicates that the WTRU does not have a home network;
receiving a registration accept message, wherein the registration accept message includes an address of a provisioning server; and
sending a request message for temporary credentials to the provisioning server using the address of the provisioning server; and
receiving the temporary credentials.

2. The method of claim 1, further comprising registering with an onboarding network using the temporary credentials.

3. The method of claim 1, wherein the WTRU is authenticated with a default credentials server prior to receiving the registration accept message.

4. The method of claim 1, wherein sending the request message for temporary credentials occurs after the WTRU establishes a user plane connection with the provisioning server.

5. The method of claim 1, wherein the registration request message includes a WTRU identifier, including a Subscription Permanent Identifier or a Subscription Concealed Identifier.

6. The method of claim 1, wherein the WTRU is an IoT device.

7. The method of claim 1, wherein the temporary credentials are dynamically created by the network based on the registration request message.

8. A wireless transmit receive unit (WTRU), the WTRU comprising:
a processor operatively coupled to a transceiver, the processor and transceiver configured to send a registration request message to a network, wherein the registration request message indicates that WTRU does not have a home network;
the processor and transceiver configured to receive a registration accept message, wherein the registration accept message includes an address of a provisioning server; and
the processor and transceiver configured to send a request message for temporary credentials to the provisioning server using the address of the provisioning server; and
the processor and transceiver configured to receive the temporary credentials.

9. The WTRU of claim 8, wherein the processor and transceiver are configured to register with an onboarding network using the temporary credentials.

10. The WTRU of claim 8, wherein the WTRU is authenticated with a default credentials server prior to receiving the registration accept message.

11. The WTRU of claim 8, wherein sending the request message for temporary credentials occurs after the WTRU establishes a user plane connection with the provisioning server.

12. The WTRU of claim 8, wherein the registration request message includes a WTRU identifier, including a Subscription Permanent Identifier or a Subscription Concealed Identifier.

13. The WTRU of claim 8, wherein the WTRU is an IoT device.

14. The WTRU of claim 8, wherein the temporary credentials are dynamically created by the network based on the registration request message.
